(19) United States
(12) Patent Application Publication
(10) Pub. No.: US 2016/0032838 A1
(43) Pub. Date: Feb. 4, 2016

(54) Cartridge Style Ejector Pump

(71) Applicant: UNITED TECHNOLOGIES CORPORATION, Hartford, CT (US)

(72) Inventor: Craig Michael Callaghan, East Granby, CT (US)

(73) Assignee: United Technologies Corporation, Hartford, CT (US)

(21) Appl. No.: 14/774,584

(22) PCT Filed: Dec. 16, 2013
(86) PCT No.: PCT/US2013/075337

§ 371 Date: Sep. 10, 2015

Related U.S. Application Data
(60) Provisional application No. 61/799,411, filed on Mar. 15, 2013.
(60) Provisional application No. 61/856,443, filed on Jul. 19, 2013.

(51) Int. Cl. F02C 7/22; F04F 5/02

(52) U.S. Cl. CPC F02C 7/222; F04F 5/02; F05D 2260/601

(57) ABSTRACT

In accordance with one aspect of the disclosure, a cartridge style ejector pump for a fluid flow system is disclosed. The ejector pump may have a body defining a flow path therein. The body may be structurally independent of the fluid flow system. The body may further define a suction inlet communicating through the body to the flow path, an outlet communicating through the body from the flow path, and a motive flow inlet communicating through the body to the flow path.

### CROSS-REFERENCE TO RELATED APPLICATIONS

This patent application is a 35 USC §371 U.S. national stage filing of International Patent Application No. PCT/US13/75337 filed on Dec. 16, 2013, which claims priority under the 35 USC §119(e) to U.S. Provisional Patent Application Ser. Nos. 61/856,443 filed on Jul. 19, 2013 and 61/799,411, filed on Mar. 15, 2013.

### FIELD OF THE DISCLOSURE

The present disclosure generally relates to fuel recovery systems and gas turbine engines and, more specifically to ejector pumps for a fuel recovery system.

### BACKGROUND OF THE DISCLOSURE

Gas turbine engines generally have a plurality of axially aligned components including a fan, a compressor section, a combustor, and a turbine section. The fan, positioned at a forward end of the engine, rotates to draw in and accelerate ambient air. Some of the accelerated air flows to the compressor section, as a core flow, where the air is compressed and then flows to the combustor. At the combustor, the compressed air is mixed with fuel and combusted to form an exhaust. The exhaust expands from the combustor through the turbine section, causing turbines of the turbine section to rotate, and then flowing out of the engine at an aft end of the engine. The rotation of the turbines drives the rotation of the fan and compressors by way of a shaft, or a plurality of concentrically mounted shafts in the case of a multi-spool engine. It can therefore be seen that once this process has begun it is self sustaining.

A fuel flow system supplies the necessary fuel for combustion to the combustor. This fuel flow system may include a fuel recovery system, also known as an ecology system, that retrieves un-combusted fuel. These systems typically employ an ejector pump to create a suction to return any un-combusted fuel back into the fuel system.

While effective, these ejector pumps are built into the fuel recovery system and cannot be easily replaced if damaged, clogged, or a different pump is desired and also require a dedicated supply and return plumbing. Therefore a new ejector pump is needed that can be easily replaced for any reason and does not need dedicated plumbing.

### SUMMARY OF THE DISCLOSURE

In accordance with one aspect of the disclosure, a cartridge style ejector pump for a fluid flow system is disclosed. The ejector pump may have a body defining a flow path therein. The body may be structurally independent of the fluid flow system. The body may further define a suction inlet communicating through the body to the flow path, an outlet communicating through the body from the flow path, and a motive flow inlet communicating through the body to the flow path.

In a refinement, the cartridge style ejector pump may be positioned within a receiving port of the fluid flow system.

In a further refinement, the cartridge style ejector pump may be removably positioned within the receiving port.

In another further refinement, the cartridge style ejector pump may further comprise a locking mechanism. The locking mechanism may be configured to secure the cartridge style ejector pump in the receiving port.

In yet a further refinement, the locking mechanism may be a threaded connection between the cartridge style ejector pump and the receiving port.

In another refinement, the cartridge style ejector pump may further include a filter. The filter may be positioned such that a fluid flowing from the suction inlet to the outlet flows through the filter.

In accordance with another aspect of the present disclosure, a fuel recovery system of a fuel supply system is disclosed. The fuel recovery system may include a receiving port open at a first end and including a housing defining a supply passage and return passage. The fuel recovery system may further include a cartridge style ejector pump having a body defining a flow path therein. The body may be structurally independent from but positioned within the housing of the receiving port. The body may further define a suction inlet communicating through the body from the fuel supply system to the flow path, and outlet communicating through the body from the flow path to the receiving port, and a motive flow inlet communicating through the body from the receiving port to the flow path.

In a refinement, the flow path of the cartridge style ejector pump may be in fluid communication with the supply passage of the receiving port via the motive flow inlet.

In another refinement, the flow path of the cartridge style ejector pump may be in fluid communication with the return passage via the outlet of the cartridge style ejector pump.

In another refinement, the flow path of the cartridge style ejector pump may be in fluid communication with a fuel manifold of the fuel supply system via the suction inlet of the cartridge style ejector pump.

In yet another refinement, the fuel recovery system may further include a locking mechanism retaining the cartridge style ejector pump in the receiving port.

In a further refinement, the locking mechanism may be a threaded connection between the cartridge style ejector pump and the receiving port.

In yet another refinement, the fuel recovery system may further include a seal formed between the cartridge style ejector pump and the receiving port.

In a further refinement, the seal may be formed by an o-ring positioned surrounding the cartridge style ejector pump and within the receiving port.

In still another refinement, the fuel supply system may be configured to provide a flow of fuel to the supply passage of the receiving port.

In still another refinement, the return passage of the receiving port may communicate to the fuel supply system.

In accordance with yet another aspect of the present disclosure, a method of operating a fuel recovery system is disclosed. The method may include inserting a cartridge style ejector pump into a receiving port through an open first end of the receiving port. The receiving port may include a housing that defines a supply passage and a return passage. The cartridge style ejector pump may have a body defining a flow path therein and be structurally independent from the fuel recovery system. The body may further define a suction inlet communicating through the body to the flow path, an outlet communicating through the body to the receiving port, and a motive flow inlet communicating through the body into the flow path. The method may further include providing a flow of fuel from the fuel supply system to the flow of the cartridge style ejector pump via the supply passage of the receiving port and the motive flow inlet of the cartridge style ejector pump, creating a suction through the inlet of the cartridge style ejector pump with the fuel flowing through the flow path of the cartridge style ejector pump from the motive flow inlet to the outlet, and discharging the flow of fuel into the fuel supply system from the flow path of the cartridge style ejector pump via the outlet of the cartridge style ejector pump and the return passage of the receiving port.

In a refinement, the method may further include retaining the cartridge style ejector pump in the receiving port with a locking mechanism.

In another refinement, the method may further include securing the cartridge style ejector pump in the receiving port with a threaded connection between the cartridge style ejector pump and the receiving port.

In still another refinement, the method may further include forming a seal between the cartridge style ejector pump and the receiving port.

These and other aspects and features of the present disclosure will be better understood in light of the following detailed description when read in light of the accompanying drawings.

### BRIEF DESCRIPTION OF THE DRAWINGS

FIG. 1 is partial perspective view of a gas turbine engine constructed in accordance with an embodiment of the present disclosure.

FIG. 2 is a schematic of a fuel system constructed in accordance with the present disclosure.

FIG. 3 is a cross-sectional view of a prior art ejector pump.

FIG. 4 is a partial perspective view of an ejector pump constructed in accordance with an embodiment of the present disclosure.

FIG. 5 is a partial perspective view of an ejector pump and receiving port constructed in accordance with an embodiment of the present disclosure.

FIG. 6 is a partial perspective view of another ejector pump and receiving port constructed in accordance with an embodiment of the present disclosure.

FIG. 7 is a cross-sectional view of another ejector pump and receiving port constructed in accordance with an embodiment of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

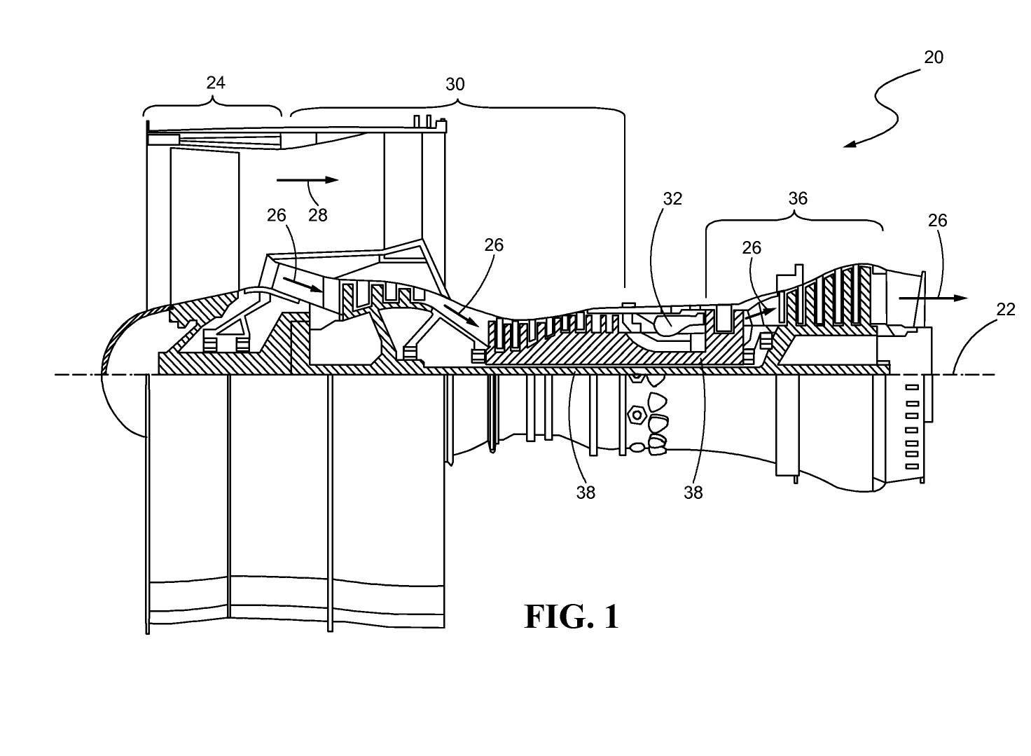

Referring now to the drawings, and with specific reference to FIG. 1, a gas turbine engine is illustrated and generally indicated by reference numeral 20. As can be seen, the engine 20 includes a plurality of components axially aligned along a central axis 22. At a forward end of the engine 20 a fan 24 rotates to draw in and pressurize ambient air. This air is split into a core flow 26 and a bypass flow 28, where the core flow 26 flows to a compressor section 30 where it is further compressed and the bypass flow 28 flows back into the atmosphere to generate thrust. From the compressor section 30, the compressed core flow 26 flows to a combustor 32 where the core flow 26 is mixed with a fuel 34 and combusted to form an exhaust. The exhaust expands through a turbine section 36 and exits the engine 20 at an aft end. As the exhaust expands, rotors of the turbine section 36 are rotated. This rotational motion is communicated to the fan 24 and rotors of the compressor section 30 via an engine shaft 38, or plurality of engine shafts 38 in the case of a dual-spool engine 20 as illustrated.

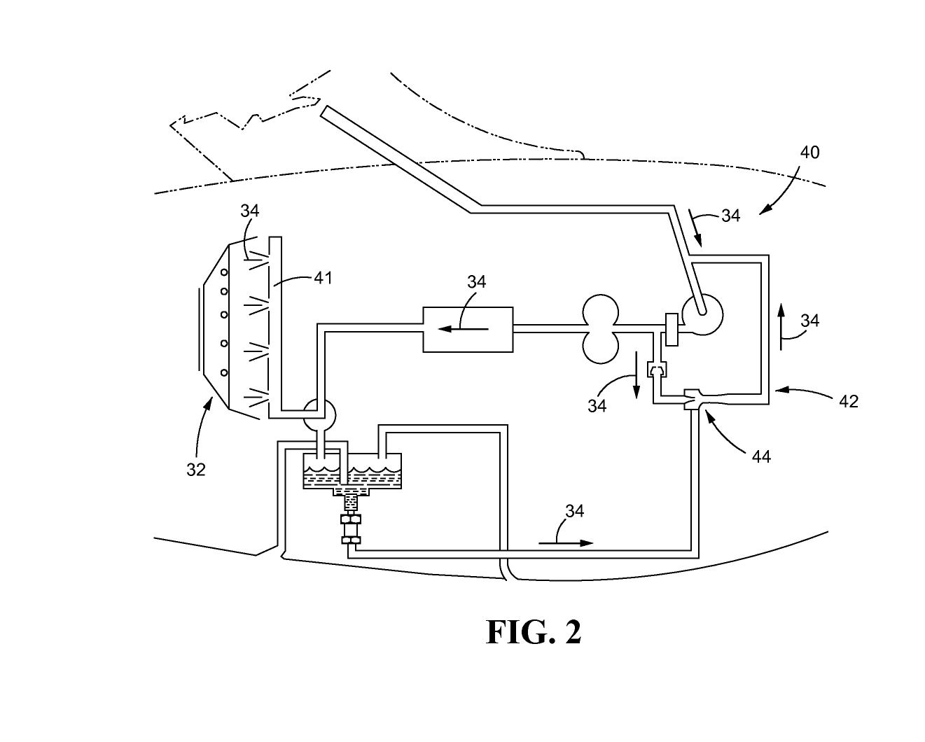

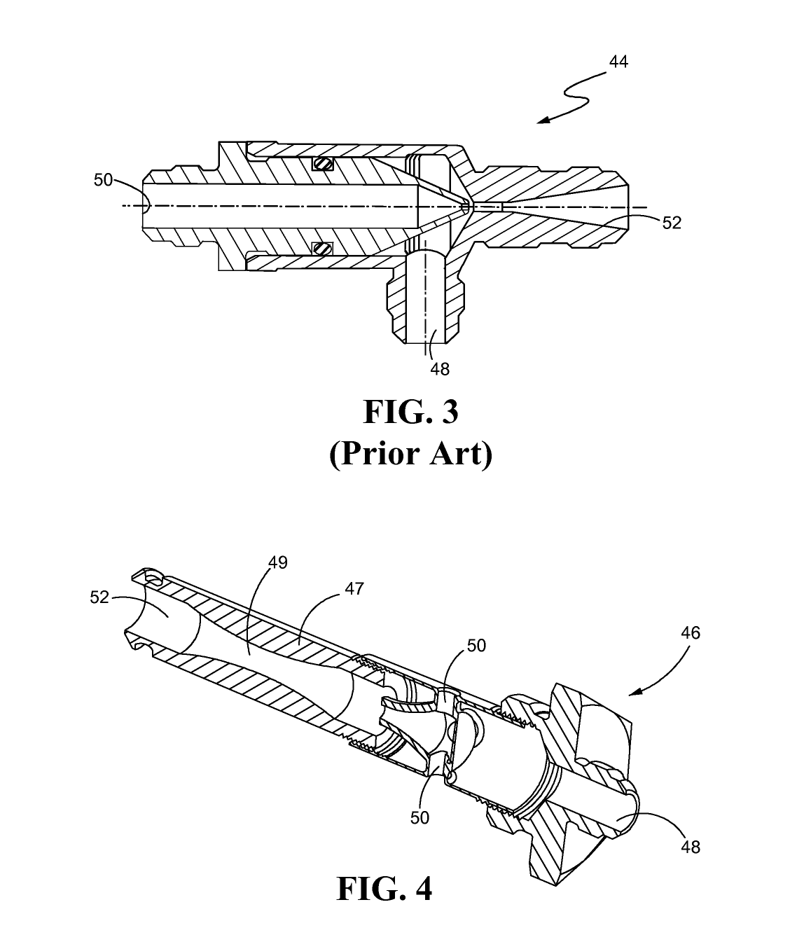

As can be seen in FIG. 2, the engine 20 may include a fuel system 40 for delivering the fuel 34 to the combustor 32. A fuel recovery system 42 is typically included in the fuel system 40 for recovering un-burnt fuel from the fuel system 40, such as from a fuel manifold 41, after the engine 20 is shut down. An ejector pump 44, such as pump 44 in FIG. 3, is used to recapture the un-burnt fuel that resides within the fuel system 40 after an engine shut off. However, as can be seen in FIGS. 2 and 3, the pump 44 is typically integrated into the fuel system 40 with additional plumbing as the fuel recovery system 42. But for the provisions of the present disclosure, this causes any maintenance or replacement of the pump 44 to require replacing larger sections of the recovery system 42 rather than just the pump.

However, with the present disclosure, as illustrated in FIG. 4, a cartridge style ejector pump 46 is provided. The cartridge style ejector pump 46 has a body 47 that defines a flow path 49 therein having a suction inlet 48 communicating through the body 47 from the fuel system 40, or more specifically from the fuel manifold 41, to the flow path 49, a motive flow inlet 50 communicating through the body 49 from the fuel system 40 to the flow path 49, and an outlet 52 communicating through the body 47 from the flow path 49 to the recovery system 42 and ultimately back to the general fuel system 40. The pump 46 has a cartridge style design in that it is structurally independent from any components of the fuel system 40 and may be removed and inserted from/into the fuel system 40.

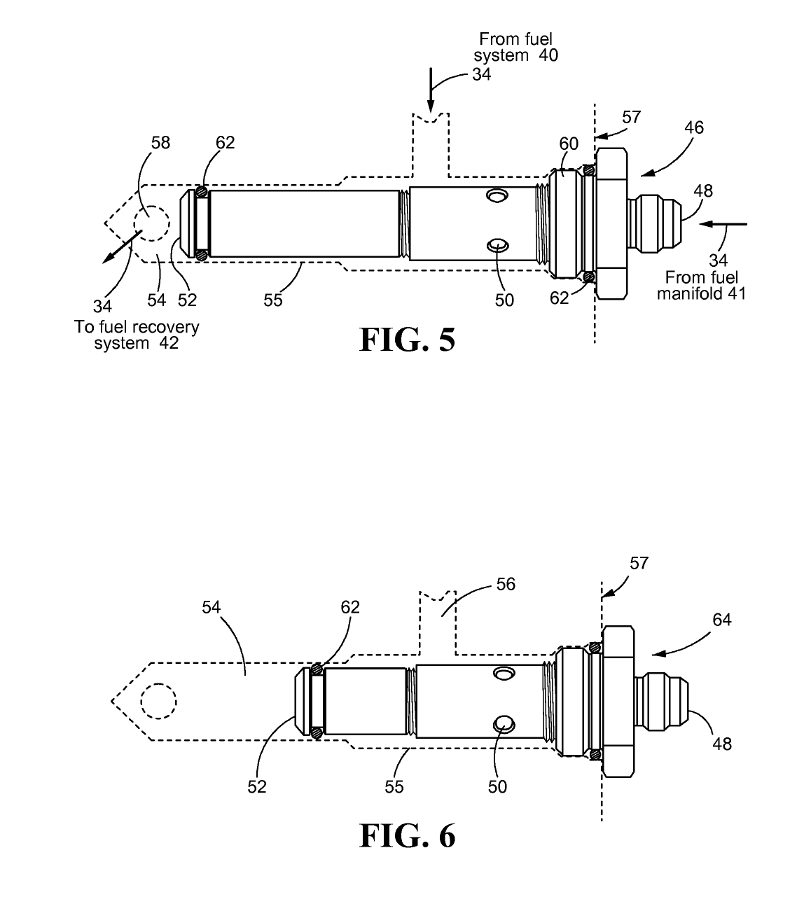

More specifically, the ejector pump 46 may be inserted into a receiving port 54, such as the one illustrated in FIG. 5, of the fuel recovery system 42. This port 54 may have a first end 57 open to the fuel manifold 41 and a housing 55 defining a supply passage 56 and a return passage 58 for transmitting the fuel 34 to the ejector pump 46 from the fuel system 40 and from the ejector pump 46 to the fuel system 40, respectively.

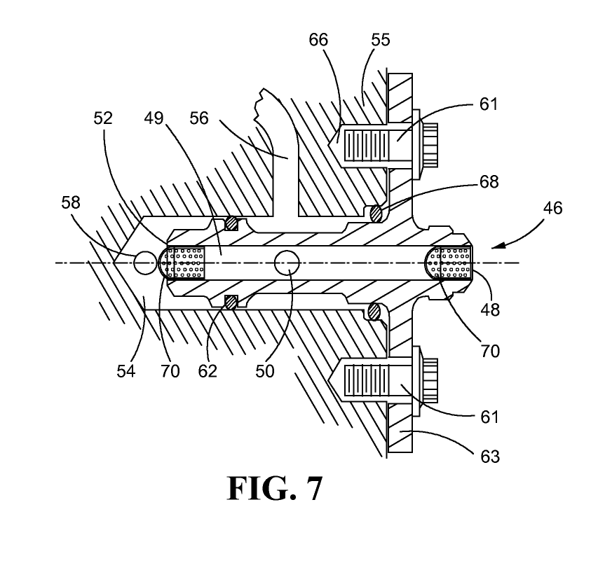

The ejector pump 46 and receiving port 54 may include a locking mechanism 60 to secure the ejector pump 46 in the receiving port 54. For example, the body 47 and housing 55 may be threaded or the pump 46 may be held in place by friction between the body 47 and housing 55. The ejector pump 46 may alternatively be retained in the receiving port 54 by a bolt 61, as illustrated in FIG. 7. This bolt 61 may extend through a flange 63 radially extending from the ejector pump 46 and thread into a locking insert 66 in the housing 55. Both of these locking mechanisms 60, as well as others, may prevent the pump 46 from moving during operation of the engine 20, but allow an operator to remove the pump 46 if desired. However, other methods of securing the pump 46 in the port 54 also exist, and these are only examples thereof.

In order to seal the flow of fuel 34 between the pump 46 and port 54 an o-ring 62, or a plurality of o-rings 62, may be used to create a seal between the pump 46 and port 54 as in FIG. 5. The o-ring 62 may be positioned proximate the outlet 52 of the pump 46 to prevent a flow of fuel from the supply passage 56 bypassing the pump 46 and flowing directly to the return passage 58. The o-ring 62 may also be positioned proximate the suction inlet 48 to prevent the flow of fuel from the supply passage 56 from flowing out of the receiving port 54 and escape the fuel system. Other seals are also possible such as, but not limited to, a face seal plate 68, rather than or in addition to the o-ring 62. This face seal plate 68 may be positioned between the flange 63 and the housing 55 to seal the connection proximate the suction port 48, as illustrated in FIG. 7.

The ejector pump 46 may further include a filter 70, as in FIG. 7, or a plurality of filters 70, to catch any unwanted materials traveling along with the flow of fuel 34. The filter 70 may be positioned such that a flow of fuel 34 from the suction inlet 48 to the outlet 52 flows through the filter 70. More specifically, the filter 70 may be positioned within the flow path 49 between the suction inlet 48 and the motive flow inlet 50. Such positioning of a filter 70 would filter only the recovered fuel 34. The filter 70 may also be positioned at the outlet 52 such that all fuel 34 exiting the ejector pump 46 must flow through the filter 70. While the filter 70 has been described in specific positions in the ejector pump 46, other locations are also possible, and the description provided should not be considered limiting, but only one example.

The cartridge nature of the pump 46 may allow the pump 46 to be replaced if the flow of recovered fuel needs to change. This may be accomplished by removing the pump 46 and inserting a different pump 46 into the port 54. However, the receiving port 54 may be configured to receive one particular size of ejector pump 46 or any number of sizes. By utilizing the o-rings 62, a different sized pump 46 may be inserted and secured in the port 54. For example, a substitute pump 64 that has a shorter axial length than the pump 46 presented in FIG. 5 may also be inserted into the same port 54 from FIG. 5, as illustrated in FIG. 6. The illustrated substitute pump 64 is only one example of how a substitute pump may be different from an originally intended pump and many others are also possible.

### INDUSTRIAL APPLICABILITY

From the foregoing, it can be seen that the technology disclosed herein has industrial applicability in a variety of settings such as, but not limited to providing a replaceable ejector pump for a fuel recovery system of a gas turbine engine. The cartridge style of the ejector pump allows the pump to be replaced should a different ejector pump be desired, the pump becomes damaged, or the pump becomes clogged. The cartage style of the ejector pump also reduces weight of the assembly and reduces the need for dedicated plumbing for the ejector pump over the prior art. The cartridge style ejector pump also can decrease cost, weight, and complexity of systems integrating the pump. The pump also increases the ease of access for maintenance purposes.

While the present disclosure has been made in reference to a gas turbine engine and an aircraft, and specifically to an ejector pump used in a fuel recovery system for a gas turbine engine, one skilled in the art will understand that the teachings herein can be used in other applications as well such as, but not limited to, providing a replaceable ejector pump for any flow system of a gas turbine engine. It is therefore intended that the scope of the invention not be limited by the embodiments presented herein as the best mode for carrying out the invention, but that the invention include all equivalents falling within the spirit and scope of the appended claims as well.

What is claimed is:

1. A cartridge style ejector pump for a fluid flow system, comprising:
a body defining a flow path therein, the body structurally independent of the fluid flow system;
a suction inlet communicating through the body to the flow path;
an outlet communicating through the body from the flow path; and
a motive flow inlet communicating through the body to the flow path.

2. The cartridge style ejector pump of claim 1, wherein the cartridge style ejector pump is positioned within a receiving port of the fluid flow system.

3. The cartridge style ejector pump of claim 2, wherein the cartridge style ejector pump to be removably positioned within the receiving port.

4. The cartridge style ejector pump of claim 2, further comprising a locking mechanism, the locking mechanism configured to secure the cartridge style ejector pump in the receiving port.

5. The cartridge style ejector pump of claim 4, where the locking mechanism is a threaded connection between the cartridge style ejector pump and the receiving port.

6. The cartridge style ejector pump of claim 1, further comprising a filter, positioned such that a fluid flowing from the suction inlet to the outlet flows through the filter.

7. A fuel recovery system of a fuel supply system, comprising:
a receiving port open at a first end and including a housing defining a supply passage and return passage; and
a cartridge style ejector pump including a body defining a flow path therein, the body structurally independent from but positioned within the housing of the receiving port, the body defining a suction inlet communicating through the body from fuel supply system to the flow path, an outlet communicating through the body from the flow path to the receiving port, and a motive flow inlet communicating through the body from the receiving port to the flow path.

8. The fuel recovery system of claim 7, wherein the flow path of the cartridge style ejector pump is in fluid communication with the supply passage of the receiving port via the motive flow inlet.

9. The fuel recovery system of claim 7, wherein the flow path of the cartridge style ejector pump is in fluid communication with the return passage via the outlet of the cartridge style ejector pump.

10. The fuel recovery system of claim 7, wherein the flow path of the cartridge style ejector pump is in fluid communication with a fuel manifold of the fuel supply system via the suction inlet of the cartridge style ejector pump,

11. The fuel recovery system of claim 7, further comprising a locking mechanism retaining the cartridge style ejector pump in the receiving port.

12. The fuel recovery system of claim 11, wherein the locking mechanism is a threaded connection between the cartridge style ejector pump and the receiving port.

13. The fuel recovery system of claim 7, further comprising a seal formed between the cartridge style ejector pump and the receiving port.

14. The fuel recovery system of claim 13, wherein the seal is formed by an o-ring positioned surrounding the cartridge style ejector pump and within the receiving port.

15. The fuel recovery system of claim 7, wherein the fuel supply system is configured to provide a flow of fuel to the supply passage of the receiving port.

16. The fuel recovery system of claim 7, wherein the return passage of the receiving port communicates to the fuel supply system.

17. A method of operating a fuel recovery system, comprising:
a receiving port inserting a cartridge style ejector pump into a receiving port through an open first end of the receiving port, the receiving port including a housing defining a supply passage and return passage, the supply and return passages in fluid communication with a fuel supply system, the cartridge style ejector pump including a body defining a flow path therein, the body structurally independent from the fuel recovery system, the body defining a suction inlet communicating through the body to the flow path, an outlet communicating through the body to the receiving port, and a motive flow inlet communicating through the body into the flow path;
providing a flow of fuel from the fuel supply system to the flow path of the cartridge style ejector pump via the supply passage of the receiving port and the motive flow inlet of the cartridge style ejector pump;
creating a suction through the suction inlet of the cartridge style ejector pump with the fuel flowing through the flow path of the cartridge style ejector pump from motive flow inlet to the outlet; and
discharging the flow of fuel into the fuel supply system from the flow path of the cartridge style ejector pump via the outlet of the cartridge style ejector pump and the return passage of the receiving port.

18. The method of claim 17, further comprising retaining the cartridge style ejector pump in the receiving port with a locking mechanism.

19. The method of claim 17, further comprising securing the cartridge style ejector pump in the receiving port with a threaded connection between the cartridge style ejector pump and the receiving port.

20. The method of claim 17, further comprising forming a seal between the cartridge style ejector pump and the receiving port.
